(19) United States
(12) Patent Application Publication
(10) Pub. No.: US 2006/0074752 A1
(43) Pub. Date: Apr. 6, 2006

(54) Method of facilitating placement of advertising

(76) Inventor: David Newmark, Tarzana, CA (US)

Correspondence Address: FULBRIGHT AND JAWORSKI LLP, 555 S. FLOWER STREET, 41ST FLOOR, LOS ANGELES, CA, 90071, US

(21) Appl. No.: 10/959,295

(22) Filed: Oct. 5, 2004

(51) Int. Cl. G06Q 30/00

(52) U.S. Cl. 705/14

(57) ABSTRACT

A method of facilitating placement of an advertisement. A specification, which includes at least a budget and a reserve cost and designates creative material for the advertisement, is received from an advertiser. A deposit of funds, in an amount that is at least equal to the budget, and the creative material, are also received from the advertiser. The specification is publicized to media carriers. One or more bids from one or more of the media carriers are received. Each received bid is compared with the specification. Those media carriers submitting bids which are below the reserve costs are identified. The creative material is then transferred to each of the identified media carriers for placement.

### BACKGROUND OF THE INVENTION

1. Field of the Invention

The field of the present invention is advertising space procurement. More particularly, the present invention relates to placement of advertising in printed publications, billboards, radio, television, web pages, web portals, and other such spaces where paid advertisements are found.

2. Background

Advertisement space is often marketed by the media carrier to perspective advertisers. Under such circumstances, the cost of the advertisement space may or may not be negotiable. To rectify the problems with non-negotiability, advertisement space has been sold in an auction format. The reverse auction format is even more advantageous to the purchaser in that it places the media carriers in direct competition for the advertising dollar.

The chief advantage of the reverse auction format is it gives the advertiser a greater ability to control the costs of purchasing the advertising space. Other advantages of the reverse auction format will generally depend upon the particular implementation. For example, U.S. Pat. No. 6,647,373, U.S. Patent Publication Nos. 2003/0041004 A1, 2003/0041005 A1, and 2003/0074303 A1, and European Patent Application No. EP 1026610 A2 all disclose advantages that may be achieved by using the reverse auction format in association with the purchase of advertising space. While each of these references disclose advantages that may be achieved using the reverse auction format, additional advantages and efficiencies of the format may still be achieved by further refinement of the overall process.

### SUMMARY OF THE INVENTION

The present invention is directed toward a method of facilitating placement of an advertisement. A specification which includes at least a budget and a reserve cost is received from an advertiser. The specification also designates creative material which is to be used for the advertisement. The host publicizes selected parts of the specification to advertising media carriers, and as a result receives one or more bids from the selected media carriers. The received bids are thereafter compared with the specification. Through the comparison, one or more media carriers are identified as the winning bidders. Thereafter, the creative material is transferred to the winning media carriers for placement as advertising. All or part of the aforementioned process may, be beneficially implemented via a network server and appropriate programming interfaces.

In a first separate aspect of the present invention, funds which are at least equal in amount to the advertising budget are received from the advertiser prior to initiation of the bidding process. These funds may be received by the host overseeing the auction or by a neutral third party.

In a second separate aspect of the present invention, the creative material is received from the advertiser prior to initiation of the bidding process. The creative material may be received by the host overseeing the auction or by a neutral third party.

In a third separate aspect of the present invention, a subset of media carriers among the bidding media carriers is identified, each of the subset of media carriers being associated with a bid below the reserve. Not all media carriers that have submitted bids below the reserve cost need be included in the subset of carriers. The subset may be identified as follows: The first media carrier of the subset is that media carrier with the lowest bid. If the award to the first media carrier does not exhaust the budget of the specification, a second media carrier with the next lowest bid is also identified as a winning bidder. If the award to the second media carrier also does not exhaust the budget, this process continues until either the budget is exhausted or there are no more bids that meet the specification requirements.

In a fourth separate aspect of the present invention, any of the foregoing aspects may be employed in combination.

Accordingly, the present invention provides an improved method of facilitating placement of an advertisement. The advantages of this invention will appear hereinafter.

### BRIEF DESCRIPTION OF THE DRAWINGS

In the drawings, wherein like reference numerals refer to similar components:

FIG. 1 schematically illustrates an implementation of a method of facilitating placement of an advertisement;

FIG. 2 schematically illustrates a second implementation of a method of facilitating placement of an advertisement; and

FIG. 3 is a flowchart illustrating a method of facilitating placement of an advertisement.

### DETAILED DESCRIPTION OF THE PREFERRED EMBODIMENTS

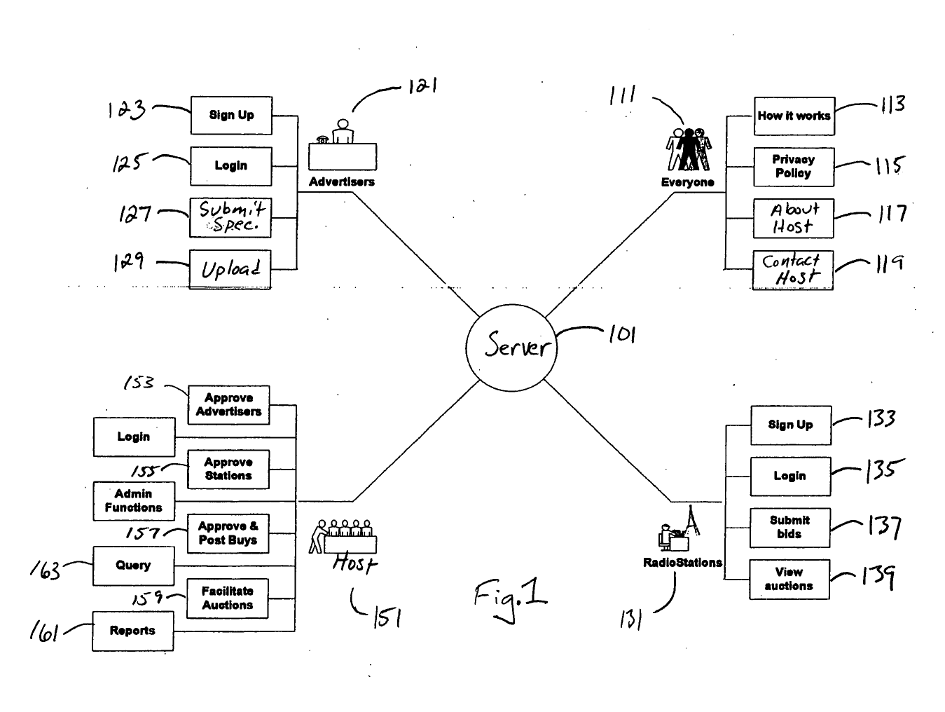

Turning in detail to the drawings, FIG. 1 schematically illustrates a system for implementing a reverse auction which may be used for placement of radio advertisements. While the following description is in the context of advertisements placed for radio broadcast, the systems and methods described are equally applicable to advertisements placed in other media, such as print ads, television broadcasts, internet ads, and the like. In addition, the system and method described below is intended to allow advertisers to purchase advertising space (“avails”) that remains unsold in the one-to-two week time period prior to the week including the desired “on-air” time. The system and method are therefore described in the context that requests to purchase avails (post an auction) are submitted not less than seven days before the targeted week (running Monday through Sunday) of “on-air” time and the auctions are initiated approximately six days prior to the start of the target week. Bids on the auction are accepted for approximately two days, at which time auctions are closed and the winning bidder(s) is/are notified. Thereafter, the advertisements are run by the winning bidder(s) in accordance with the terms and conditions of the auction. The system and method, however, are not limited to use solely within the aforementioned context, as the auction parameters may vary widely without altering the essence of the invention.

The system includes a network server 101 connected to the Internet. The network server 101 allows interested parties to access stored information via a series of web pages, communicate electronically and complete desired transactions. The network server 101 is also configured to provide the host, advertisers, and media carriers with automatic email notices where and when appropriate. Such automatic notification greater facilitates the purchase transactions described herein.

The network server 101 may be accessed by the various parties either directly through a direct network connection or other method, such as a dial-up connection, or indirectly over a public network such as the internet. Different parties have different levels of access to information residing on the network server 101. In general, everyone 111 is provided limited access to the stored information. The limited amount of information available to everyone 111 includes how the advertisement placement process, available through the network server 101, works 113, the privacy policy 115 of the host 151, additional information 117 about the host 151 (including that information which the host wishes to make publicly available), and contact information 119, which enables interested parties to contact the host directly.

Advertisers 121 and radio stations 131 are each given limited access to nonpublic information stored on the network server 101. Both advertisers 121 and radio stations 131 are permitted to change certain information which resides on the network server 101. Each of these parties is generally permitted to change the private contact information which is associated with each respective party. Where appropriate, the host 151 may direct the network server 101 to permit the advertisers 121 and radio stations 131 to change other information stored on the network server 101. For certain changes, the network server 101 may be configured to require host approval before those changes are integrated into the system. In general, the host 151 performs all administrative functions relating to the network server 101 that are necessary. Among these administrative functions is the ability to grant and deny access as desired.

The advertisers 121 are given access to the network server 101 to perform four primary functions, although additional secondary functions may also be granted. These four primary functions include signing up 123 as an advertiser to establish a private account, logging in 125 to a private account previously established, submitting specifications 127 in order to purchase advertising space, and uploading 129 creative material and/or funds to the network server 101 during the transaction process. The radio stations 131 are similarly granted access to four primary functions available on the network server 101. As with the advertisers 121, the radio stations 131 may also be granted access to secondary functions. The primary functions available to the radio stations 131 include signing up 133 as a radio station available to carry advertising, thereby establishing a private account, logging in 135 to an established account, submitting bids 137 in response to a specification posted by an advertiser, and reviewing available auctions 139.

As indicated, the host 151 has administrative access to the network server 101. This means that the host may view and change any information residing on the network server 101. In addition, the host 151 performs duties which further facilitate an advertiser's purchase of advertising space. These duties include pre-approving advertisers 153, pre-approving stations 155, approving and posting 157 specifications for an auction, generally facilitating 159 the auction process, and running queries 163 and reports 161 from the information stored on the network server. These queries 163 and reports 161 may be customized through standard programming interfaces to suit the needs of the host 151.

Before initiating any transactions, an advertiser signs up with the system and provides identifying information. The advertiser preferably provides this information by accessing one or more web pages stored on the network server 101 for this particular purpose. Basic contact information is requested: advertiser name, advertiser address, and the name, title, phone number, fax number and e-mail address of one or more individuals who will be authorized to access the network server on behalf of the advertiser. In addition, at this initial sign-up stage, the advertiser is asked to provide default instructions for handling excess funds following the close of an auction. Two different fund-handling options are detailed below. Upon receipt of this initial sign-up information, the host establishes an advertiser profile and prepares and provides paperwork to the advertiser to establish a contract whereby the advertiser agrees to abide by the terms and conditions of the services being provided by the host. Following completion of these formalities, the host activates the advertisers account on the network server 101.

Each advertiser's account has one or more authorized users associated therewith. Users fall into one of three categories: executive users, standard users, and read-only users. Each user has an associated user profile. Executive users can access all aspects of an account and perform any task associated with the account, including creating additional users of any type, editing the profile information associated with any user, and initiating or modifying any auction associated with the advertiser. Standard users can initiate auctions on behalf of the advertiser, but can only modify auctions that were created by that particular user. These standard users are also able to view any user profile, but they can only modify their own user profile. Read-only users are able to view all information associated with the advertiser, but cannot modify any information except for that particular user's own profile.

Media carriers also sign up via the web pages stored on the network server 101. The media carrier provides an account name and contact information for one or more users associates with the account. Where the media carrier is acting on behalf of one or more radio stations, the call letters of each radio station is also provided. The users associated with a media carrier may be granted one of three levels of access: executive users, standard users, and read-only users. The executive users can access all information associated with the media carriers account and may modify any of that information, including bids that are placed in response to an auction. Standard users can place bids for an auction, modify bids placed by that user, and modify their own respective profile. A media carrier having more than one radio station may optionally limit a standard user to placing bids on behalf of a selected subset of the radio stations controlled by that media carrier. Read-only users can read or view all information associated with the media carrier, but cannot modify any information except the information which is associated with the read-only user's profile.

Upon the media carrier's completion of the initial sign-up process, the host verifies that the station call letters entered by the media carrier are valid based upon known radio stations throughout the areas being served. Using the call letters, the host gathers additional information from an appropriate ratings service to complete the media carrier's profile. In radio, Arbitron, Inc. of New York, N.Y. is presently the sole provider of ratings in the radio market. Information that may be gathered from the rating service include each station's format, market, designated market area (DMA), and ratings in various demographic categories. The ratings are generally expressed in the form of an average quarter hour (AQH) for a given demographic audience. AQH is defined within the radio industry as the total number of listeners tuned in to a specific radio program for a minimum of five minutes within a fifteen minute period. When completing the profile information for a radio station, the host preferably averages the two most recent Arbitron ratings surveys to come up with an average AQH. Other methodologies of completing a radio station's profile information may also be used.

As with the advertisers, the media carriers are asked to complete necessary legal paperwork to insure that the media carrier agrees to abide by the established terms and conditions of the host. Such contracts preferably include terms whereby media carriers guarantee that the advertisements will air following a winning bid and that the advertisements are not preemptible. Following completion of the above formalities, the host activates the media carrier's account on the network server 101.

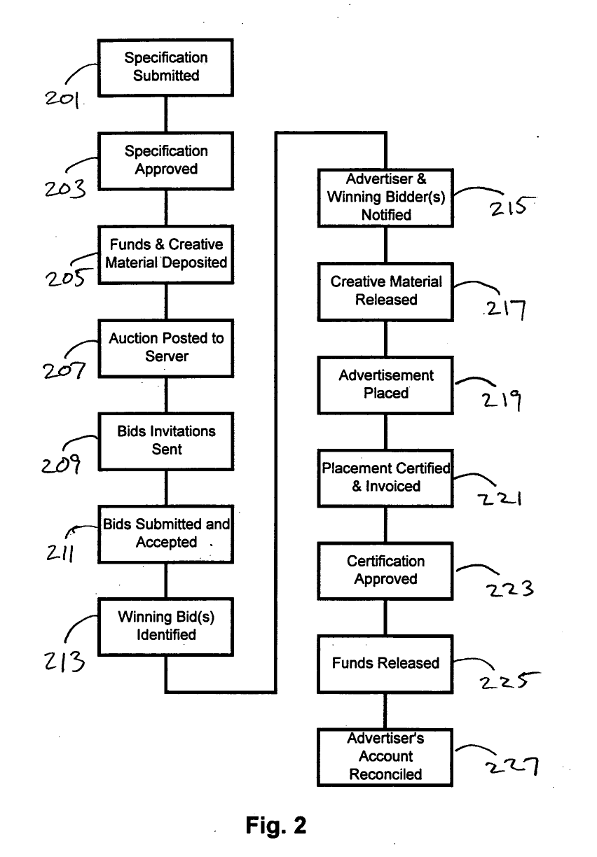

FIG. 2 is a flow chart which illustrates the process that the host, the advertiser, and the radio stations go through so that the advertiser may place an advertisement with a radio station. This process may be used by the advertiser to place a single advertisement with a single radio station, the advertisement running one or more times, or to place two or more advertisements with multiple radio stations, each advertisement running one or more times. In the latter instance, the advertiser is effectively creating an entire advertising campaign to advertise the product or service being sold.

To initiate a transaction for purchasing advertising space using the present system and methods, the advertiser logs into an active account on the network server and, using web pages specifically designed for this task, enters the specification for placement of the advertisement. The advertiser may modify the specification at any time prior to approval of the specification by the host. The specification includes the following:
Advertiser. This identifies the name of the advertiser who is purchasing the advertising space. Preferably, the network server completes this information based upon the profile of the user creating the specification.
Advertising period. The advertiser identifies the desired week for running the advertisement(s).
Description. This includes a short description or overview of the purchase the advertiser wishes to make.
Budget. This is the maximum dollar amount the advertiser wishes to spend. The amount applies to all advertisements being placed through a single auction.
Demographic. This identifies the demographics the advertiser wishes to target. The advertiser may target specific gender and age groups. The categories of demographics available to an advertiser are preferably identical to the demographic categories used by Arbitron, Inc. Preferably, the gender options are male, female, and all adults, and the age options are 25+, 25-34, 5-44, 45-54, 55-64, and 65+.
Format. This identifies the advertiser's desired media format, e.g., the type of radio station or stations on which the advertiser wishes to place the advertisement. Many different media formats are available in radio, for example, talk radio, news, country, classical, pop, etc. The media format may also identify the language of the radio stations on which the advertisement is to be placed.
Day Parts. This identifies the time slot in which the advertiser wants to place the advertisement. Generally, within the radio industry, day parts are broken up into two segments, the day and the time. The day portion of the day parts includes Monday through Friday, Saturday, and Sunday. The time portion of the day parts include six different time periods: Rotator (6 a.m. to Midnight), Morning Drive or AM Drive (5 a.m. to 10 a.m.), Mid Day (10 a.m. to 3 p.m.), Afternoon Drive or PM Drive (3 p.m. to 7 p.m.), Night (7 p.m. to Midnight), and Overnight (Midnight to 5 a.m.). The advertiser may identify any one or multiple day parts in which the advertisement will be run. The advertiser may place a restriction requirement on the day parts. Such a restriction would require a media carrier to bid on all day parts included in the specification and would set a required distribution of the advertisement across the selected day parts. The advertiser may also elect to place no restrictions on the day parts. In such instances, media carriers may bid on any one or all of the day parts identified in the specification. Where more than one day parts is selected, the advertiser may be given the option to place a separate budgetary constraint on any given day part. By default, the only budget constraint placed on any single day parts is the budget for the auction as a whole. A separate budgetary constraint on a day part should be less than the total budget allocated for the auction and limits the amount the advertiser is willing to spend on advertisements placed within the constrained day part. Note that by placing a restriction requirement on the day parts, the advertiser places a de facto constraint on the budget of all day parts.
Market. The advertiser selects the market criteria for the radio stations on which the advertisement is to be placed. The market criteria identifies the radio advertising market or markets. In the U.S., the radio advertising market is broken up into 205 DMA's. Further, each market is ranked by Arbitron, Inc. The advertiser may select specified markets, may select markets based on the Arbitron rankings, may select the least expensive markets based on cost per thousands by demographics, or may use any other criteria for selecting markets.
Number of Spots. The advertiser identifies the number of advertisements (called spots) that will be placed through the auction.
Spot Length. The advertiser specifies the length of the advertisement(s). Preferably, the advertiser is given the option of two or more pre-defined spot lengths, such as thirty seconds and one minute lengths. Other spot length options may also be provided to the advertiser.
Type of Spot. The advertiser indicates the format of the advertisement(s) to be placed. Advertisements may consist of pre-produced audio that is provided to the radio station as a finished product and is ready for airing. Such advertisements are generally provided in a common computer-readable format, such as WAV, AIFF, MP3, or the like. Advertisements may also consist of text that is to be read by personnel at the radio station. Finally, advertisements may consist of any combination of pre-produced audio and text. Regardless of the form of the advertisement, the advertiser provides detailed instructions for running the spot. In order for the processes described herein to proceed smoothly and without significant delays, the advertiser should have the spots in a ready-for-broadcast format at the time of submitting the specification for approval.
Traffic Instructions/Restrictions. The advertiser identifies criteria for running multiple advertisements within any particular day part. For example, the advertiser may require that a first advertisement runs twice within a selected day part, while a second advertisement runs three times within the same selected day part. If only a single advertisement is being placed, then the traffic instructions default to the advertisement being evenly rotated within all specified day parts.
Maximum Number of Spots Per Station or Day Part. The advertiser identifies the maximum number of spots to be run on any given station or during any single day part during a particular time period, preferably during any one week.
Maximum CPM. This is the reserve cost of the upcoming auction. CPM is defined as the cost per thousand listeners in a particular day part. The advertiser specifies a maximum CPM for placement of the advertisement in each of the day parts selected. Assuming that a bid meets all other criteria defined in a specification, the maximum CPM is the yardstick by which the bid is measured.

Following the advertiser's submission 201 of the specification, the host receives notice of the specification so that it can be reviewed to insure it is ready for the bidding process. Should any information be missing from the specification, or should any additional information be necessary to complete the specification, the host contacts the advertiser to obtain the additional information and complete the specification. Once complete, and if such is appropriate, the host approves 203 the specification and the advertiser is notified of the approval. The advertiser thereafter transfers 205 the funds, equal to the total budget listed in the specification, and the creative material, i.e., the advertisement(s), to the host. The host maintains control of the funds and creative material during the course of the auction

After receipt of the funds and the creative material, the host posts 207 the auction to the server. The network server is configured to automatically send out 209 bid invitations to radio stations that meet the demographic format and market criteria of the specification upon posting of the new auction.

The media carriers access the central server to submit 211 bids for carrying the advertisements. The bidding media carriers preferably have access to all information in the specification with the exception of that information related to financials, e.g., the budget and the maximum CPM. When submitting a bid, the media carrier submits the call letters of the station which will air the advertisement should the bid be a winning bid, the day parts to which the bid applies, the number of spots being offered during those day parts, and the cost of each spot. In unrestricted auctions, Media carriers may bid on select day parts within the auction and need not bid on all day parts included therein. If the auction calls for placement of advertisements in multiple day parts and requires any bidder to run the advertisements during each of those day parts, then a bid must address each of the day parts included in the specification and conform to all day parts restrictions. Failure to comply with the requirements set for the in the specification will result in the network server rejecting the bid. However, if a bid on multiple day parts conforms to the specification for one day part but not for a second day part, then the bid is accepted, but the non-conforming portion of the bid will not be considered for purposes of evaluating the winning bid(s). All bids accepted by the network server are evaluated to determine the bid CPM for each day part that is bid upon. The CPM for each day part winning bid(s) is calculated as the cost per spot of the bid divided by the AQH during that particular day spot for the given demographic audience. To assist media carriers in evaluating their bids, and whether or not they have submitted a potentially winning bid, the network server rates the bid CPM for each day part according to an index which is scaled to have the maximum CPM in the specification correspond to a value of 100. The index may be linear such that a dollar decrease in the bid CPM results in a 1 point decrease in the index. Alternatively, the index may be curved using, for example, a logarithmic algorithm. The purpose of the index is to mask means by which the bids are evaluated, while still providing media carriers with feedback on their bids.

After the prearranged closing time of the auction, the network server identifies 213 all winning bids and sends out 215 notifications to the winning media carriers and to the advertiser. Winning bids are determined by ranking all accepted bids by the assigned index value. The bid with the lowest index value below 100 is the first winning bid. If two bids have the same index value, then the first submitted bid is the winning bid. If funds remain in the budget after the first winning bid is awarded, then the bid with the next lowest index value below 100 is also a winning bid. Again, if funds remain in the budget, then additional winning bids are identified. This process continues until either the funds in the budget are exhausted or there are no more bids having an assigned index value under 100.

The winner notifications include instructions on how the winning media carriers are to obtain the creative material and how they are to obtain payment following completion of the advertising run. By following the instructions in the winning bid notices, the creative material is released 217 to the winning media carriers. These winning media carriers place 219 the advertisements in accordance with the agreement established by the specification and the terms and conditions of the auction that are pre-established and maintained by the host.

After all advertisements have run as agreed upon, the winning media carriers submit 221 a certification that the advertisements ran as agreed, and may also submit 221 an invoice to the host via the network server. The host reviews and approves 223 the certification and invoice to determine if both meet with all the terms and conditions of the auction. Thereafter, funds are released 225 to the compliant media carriers. This process is repeated for each of the winning media carriers, after which the advertiser's account is reconciled 227 and any remaining funds in that account may be returned to the advertiser if such was previously requested. Otherwise, the funds remain on account for the advertiser's next auction.

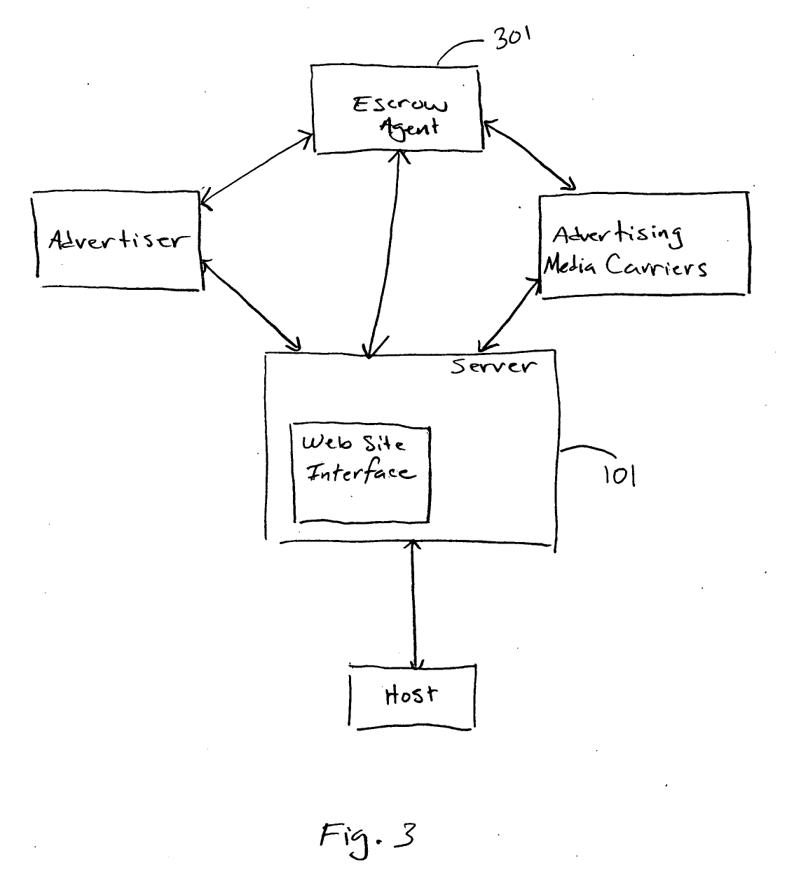

FIG. 3 illustrates an embodiment of the above-described system and method which includes a third party escrow agent 301. The escrow agent 301 is provided limited, read-only access to the network server 101 to obtain the contact information of parties to transactions involving the escrow agent 301 and to check on the status of those transactions. The escrow agent 301 acts as a neutral third party with whom the budgeted funds and creative material are deposited for the duration of the auction process. The network server 101 enables the other parties to a transaction to communicate with the escrow agent 301 and provides automatic notices to alert the escrow agent 301 as to funds and creative materials that are being deposited, when such funds and creative materials should be released, and to whom they should be released. Thus, in such an embodiment, the escrow agent 301 essentially takes over the previously-described duties of the host in all respects with regard to the funds and the creative material.

### EXAMPLE 1

A non-restrictive specification is one that includes more than one day parts and permits media carriers to bid on any of the day parts. Table 1 illustrates a partial specification that only includes budgetary restrictions on the bids.

TABLE 1
A Non-Restrictive Specification

| | |
|---|---|
| Total Budget | $50,000 |
| Demographics | Adult 25+ |
| Market | Milwaukee |
| Day parts(1) | AM drive |
| Max CPM(1) | $40 |
| Max Budget(1) | $40,000 |
| Day parts(2) | PM drive |
| Max CPM(2) | $30 |
| Max Budget(2) | $40,000 |
| Max Spots | 40 |

The sum of all maximum budgets for each day parts does not have to add up to the total budget. Media carriers may bid on any one, any subset, or all of the day parts included in the specification, limited only by a particular media carrier's inventory of avails. For such non-restrictive specifications, it is possible that one or more of the day parts will not be bid upon, with the result that no advertisements will be placed in those day parts.

### EXAMPLE 2

A restrictive specification is one that includes more than one day parts and does not permit media carriers to bid separately on the individual day parts. Table 2 illustrates a partial specification that places such restrictions on the bids.

TABLE 2
A Restrictive Specification

| | |
|---|---|
| Total Budget | $50,000 |
| Day parts(1) | AM drive |
| Max CPM(1) | $14 |
| Restriction(1) | 40% |
| Day parts(2) | PM drive |
| Max CPM(2) | $13 |
| Restriction(2) | 60% |

For this type of specification, media carriers submitting bids must conform to the 40% and 60% split. In other words, a media carrier must allocate at least 2 spots for the morning drive and at least 3 spots for the PM drive, or any increments thereof. In the case of media carriers that represent multiple radio stations, these restrictions are preferably enforced at each radio station, and not across the multiple radio stations.

### EXAMPLE 3

Building on Example 1 above, the following illustrates the how the network server processes bids and identifies the winning media carrier(s) for a non-restrictive specification. This example makes a direct comparison between the bids and the maximum CPM in the specification and does not employ the index value referred to above. Using the specification listed in Table 1, Table 3 illustrates a sample bid from Media Carrier A that meets the market and demographics criteria of the specification. Media Carrier A places bids on behalf of two radio stations and has bid more than the maximum number of spots per station, but because the number of spots per day part is less than the maximum number listed in the specification, the bid is accepted.

TABLE 3
Media Carrier A Bid
Station WJJJ-FM

| Day parts(1) | AM drive |
|---|---|
| # of Spots(1) | 30 |
| Cost per Spot(1) | $300 |
| Assigned AQH(1) | 10,700 |
| Calculated CPM(1) | $28.04 |
| Day parts(2) | PM drive |
| # of Spots(2) | 15 |
| Cost per Spot(2) | $128 |
| Assigned AQH(2) | 8,400 |
| Calculated CPM(2) | $15.24 |
| Day parts(1) | AM drive |
| # of Spots(1) | 22 |
| Cost per Spot(1) | $320 |
| Assigned AQH(1) | 19,100 |
| Calculated CPM(1) | $16.75 |
| Day parts(2) | PM drive |
| # of Spots(2) | 20 |
| Cost per Spot(2) | $98 |
| Assigned AQH(2) | 6,800 |
| Calculated CPM(2) | $14.14 |

Table 4 illustrates a sample bid from Media Carrier B that meets the market and demographics criteria of the specification. Media Carrier B represents one radio station and submits a bid for only one of the day parts listed in the specification.

TABLE 4
Media Carrier B Bid
Station WTTT-FM

| Day parts(1) | AM drive |
|---|---|
| # of Spots(1) | 40 |
| Cost per Spot(1) | $720 |
| Assigned AQH(1) | 35,700 |
| Calculated CPM(1) | $20.17 |

Table 5 illustrates a sample bid from Media Carrier C that meets the market and demographics criteria of the specification. Media Carrier C represents one radio station and submits a bid for both day parts listed in the specification. The bid Media Carrier C submits for the AM Drive day part exceeds the maximum CPM listed in the specification. The companion bid for the PM Drive day part, however, meets all specification criteria. Because at least one part of Media Carrier C's bid satisfies the specification, the overall bid is accepted and the non-conforming portion of the bid is ignored.

TABLE 5
Media Carrier C Bid
Station WHHH-FM

| Day parts(1) | AM drive |
|---|---|
| # of Spots(1) | 40 |
| Cost per Spot(1) | $620 |
| Assigned AQH(1) | 27,100 |
| Calculated CPM(1) | $22.88 |
| Day parts(2) | PM drive |
| # of Spots(2) | 32 |
| Cost per Spot(2) | $420 |
| Assigned AQH(2) | 13,600 |
| Calculated CPM(2) | $30.88 |

Table 6 shows the bids of Tables 3-5 listed in order of lowest CPM to highest. Those bids exceeding the maximum CPM are omitted from Table 6.

TABLE 6
Bid Summary

| Radio Station | Day Part | Bid CPM |
|---|---|---|
| WLLL-FM | PM drive | $14.14 |
| WJJJ-FM | PM drive | $15.24 |
| WLLL-FM | AM drive | $16.75 |
| WTTT-FM | AM drive | $20.17 |
| WHHH-FM | AM drive | $22.88 |
| WJJJ-FM | AM drive | $28.04 |

Table 7 shows the winning bids from this example, the number of spots the winning bidders will run, the day parts in which those spots will run, and the total cost to the advertiser for running those spots. The last-listed winning bidder is only awarded six of the seven spots that were included in the bid for the AM Drive day part. This limitation occurs because the maximum budget for the AM Drive day part listed in the specification would be exceeded if all seven spots of the bid are awarded. The total amount of advertisers funds spent as a result of this process is $43,440. Following reconciliation of the advertiser's account, the remaining $6,560 may either be returned to the advertiser or remain with the host or escrow agent pending the next auction initiated by that advertiser.

TABLE 7
Winning Bidders

| Radio Station | Day Part | # of Spots | Cost per Spot | Total Cost |
|---|---|---|---|---|
| WLLL-FM | PM drive | 20 | $98 | $1,960 |
| WJJJ-FM | PM drive | 15 | $128 | $1,920 |
| WLLL-FM | AM drive | 22 | $320 | $7,040 |
| WTTT-FM | AM drive | 40 | $720 | $28,800 |
| WHHH-FM | AM drive | 6 | $620 | $3,720 |

Thus, an improved method of facilitating placement of an advertisement is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method of facilitating placement of an advertisement comprising:
receiving a specification from an advertiser, the specification including at least a budget and a reserve cost and designating creative material for the advertisement;
receiving a deposit of funds from the advertiser, the deposit being in an amount that is at least equal to the budget;
receiving the creative material from the advertiser, then;
publicizing the specification to media carriers;
receiving one or more bids from one or more of the media carriers;
comparing the received bids with the specification;
identifying a subset of media carriers among the bidding media carriers, each of the subset of media carriers being associated with a bid below the reserve cost; and
transferring the creative material to each of the subset of media carriers for placement.

2. The method of claim 1, wherein receiving the specification includes receiving the specification via a network server.

3. The method of claim 1, the specification further including one or more of the following: market criteria, advertisement format, media format, target demographics, and copy instructions.

4. The method of claim 3 wherein publicizing the specification includes
identifying media carriers which meet at least one of the market criteria, the media format, or the target demographics; and
inviting the identified media carriers to bid on the specification.

5. The method of claim 1, wherein comparing the received bids with the specification includes comparing the received bids with the reserve cost.

6. The method of claim 1, wherein receiving the deposit of funds includes the advertiser submitting the deposit of funds to an escrow agent.

7. The method of claim 1, wherein receiving creative material includes the advertiser submitting the creative material to an escrow agent.

8. The method of claim 1, wherein publicizing the specification includes publishing selected parts of the specification on a network server such that the selected parts of the specification are accessible to at least the media carriers.

9. The method of claim 1, wherein receiving the one or more bids includes receiving the one or more bids via a network server.

10. The method of claim 1 further comprising verifying that each of the subset of media carriers placed the advertisement.

11. The method of claim 1 further comprising paying each of the subset of media carriers from the deposit of funds.

12. The method of claim 1 further comprising providing to the advertiser information identifying each of the subset of media carriers and each of the associated bids, respectively.

13. The method of claim 1, wherein the subset of media carriers consists of a first carrier associated with a lowest bid below the reserve cost.

14. The method of claim 1, wherein receiving the one or more bids from the one or more media carriers includes contractually obligating each bidding carrier to place the advertisement following receipt of the creative material.

15. A method of facilitating placement of an advertisement comprising:
receiving a specification from an advertiser, the specification including at least a budget and a reserve cost and designating creative material for the advertisement;
receiving at an escrow agent a deposit of funds from the advertiser, the deposit being in an amount that is at least equal to the budget;
receiving at the escrow agent the creative material from the advertiser, then;
publicizing the specification to media carriers;
receiving one or more bids on the publicized specification from one or more of the media carriers;
comparing the received bids with at least the reserve cost;
identifying a subset of media carriers among the media carriers submitting bids, each of the subset of media carriers being associated with a bid below the reserve cost;
directing the escrow agent to transfer the creative material to each of the subset of media carriers for placement; and
directing the escrow agent to transfer monies from the deposit of funds to each of the subset of media carriers.

16. The method of claim 15, wherein receiving the specification includes receiving the specification via a network server.

17. The method of claim 15, the specification further including one or more of the following: market criteria, advertisement format, media format, target demographics, and copy instructions.

18. The method of claim 17 wherein publicizing the specification includes
identifying media carriers which meet at least one of the market criteria, the media format, or the target demographics; and
inviting the identified media carriers to bid on the specification.

19. The method of claim 15, wherein publicizing the specification includes publishing selected parts of the specification on a network server such that the selected parts of the specification are accessible to at least the media carriers.

20. The method of claim 15, wherein receiving the one or more bids includes receiving the one or more bids via a network server.

21. The method of claim 15 further comprising verifying that each of the subset of media carriers placed the advertisement before directing the escrow agent to transfer monies.

22. The method of claim 15 further comprising providing to the advertiser information identifying each of the subset of media carriers and each of the associated bids, respectively.

23. The method of claim 15, wherein the subset of media carriers consists of a first carrier associated with a lowest bid below the reserve cost.

24. The method of claim 15, wherein receiving the one or more bids from the one or more media carriers includes contractually obligating each bidding carrier to place the advertisement following receipt of the creative material.

25. A method of facilitating placement of an advertisement comprising:
receiving a specification from an advertiser, the specification including at least a budget and a reserve cost, designating creative material for the advertisement, and further including one or more of the following: market criteria, advertisement format, media format, target demographics, and copy instructions;
receiving at an escrow agent a deposit of funds from the advertiser, the deposit being in an amount that is at least equal to the budget;
receiving at the escrow agent the creative material from the advertiser, then;
identifying media carriers which meet at least one of the market criteria, the media format, or the target demographics; and
inviting the identified media carriers to bid on the specification;
receiving one or more bids on the publicized specification from one or more of the identified media carriers;
comparing the received bids with at least the reserve cost;
identifying a subset of media carriers among the media carriers submitting bids, each of the subset of media carriers being associated with a bid below the reserve cost;
directing the escrow agent to transfer the creative material to each of the subset of media carriers for placement;
verifying that each of the subset of media carriers placed the advertisement; and then
directing the escrow agent to transfer monies from the deposit of funds to each of the subset of media carriers.

26. The method of claim 25, wherein receiving the specification includes receiving the specification via a network server.

27. The method of claim 25, wherein receiving the one or more bids includes receiving the one or more bids via a network server.

28. The method of claim 25 further comprising providing to the advertiser information identifying each of the subset of media carriers and each of the associated bids, respectively.

29. The method of claim 25, wherein the subset of media carriers consists of a first carrier associated with a lowest bid below the reserve cost.

30. The method of claim 25, wherein receiving the one or more bids from the identified media carriers includes contractually obligating each bidding carrier to place the advertisement following receipt of the creative material.
